(19) United States
(12) Patent Application Publication
(10) Pub. No.: US 2014/0136419 A1
(43) Pub. Date: May 15, 2014

(54) LIMITED USE TOKENS GRANTING PERMISSION FOR BIOMETRIC IDENTITY VERIFICATION

(71) Applicant: Keith Shoji Kiyohara, Santa Monica, CA (US)

(72) Inventor: Keith Shoji Kiyohara, Santa Monica, CA (US)

(21) Appl. No.: 13/673,940

(22) Filed: Nov. 9, 2012

(51) Int. Cl. G06Q 20/36; G06Q 20/32

(52) U.S. Cl. CPC G06Q 20/3674; G06Q 20/32; G06Q 20/3278; G06Q 20/206
USPC 705/67

(57) ABSTRACT

Systems and methods are described herein for granting permission for biometric identity verification by a third-party using a limited-use token. A merchant point of sale (“POS”) system may receive transaction payment information from a mobile device associated with a customer. The customer may consent to biometric verification allowing the mobile device to provide customer identification information and a biometric verification token to the POS system. The POS system can collect a sample of biometric information from the customer. The biometric verification token may be transmitted to an identity verification service to be authenticated as originating from the mobile device of the customer. Upon successful authentication of the biometric verification token by the identity verification service, the service may evaluate the biometric information collected from the customer as corresponding to the customer identification or not.

### TECHNICAL FIELD

The present disclosure relates to systems and methods for third party verification of biometric identification information, and, more particularly, to user provided tokens granting access to biometric verification of the user's identify.

### BACKGROUND

Biometric identification techniques, such as facial recognition, voice print matching, fingerprint analysis, and so forth, may be used to recognize, identify, or authenticate an individual. Many individuals, in protecting their privacy, do not wish their presence or whereabouts to be arbitrarily identified in public. In general, individuals are wary of sharing fingerprint patterns or other biometric information. For example, customers may not be comfortable with every merchant with whom they have transactions storing the patterns and biometric data necessary to identify the customer at any time. However, automated verification of biometric information may be useful in securing financial and other transactions. Hence, a need exists for a trusted third-party to provide a biometric verification service. There also is need to empower customers to knowingly provide one time, or limited time, permission to the trusted third-party to verify the customer's biometric information to the merchant.

### SUMMARY

In certain example embodiments described herein, methods and systems can grant permission for biometric identity verification by a third-party using a limited-use token. A merchant point of sale (“POS”) system may receive transaction payment information from a mobile device associated with a customer. The mobile device also may provide customer identification information and a biometric verification token to the POS system. The POS system can collect a sample of biometric information from the customer. The biometric verification token may be transmitted to an identity verification service to be authenticated as originating from the mobile device of the customer. Upon successful authentication of the biometric verification token by the identity verification service, the service may evaluate the biometric information as corresponding to the customer identification or not.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an identity verification system using biometric verification tokens to grant identity verification permission in accordance with one or more embodiments presented herein.

FIG. 2 is a block flow diagram depicting a method for processing transactions with identity verification from a mobile device in accordance with one or more embodiments presented herein.

FIG. 3 is a block flow diagram depicting a method for processing transactions with identity verification at a POS system in accordance with one or more embodiments presented herein.

FIG. 4 is a block flow diagram depicting a method for processing transactions with identity verification at a transaction processing server in accordance with one or more embodiments presented herein.

FIG. 5 is a block flow diagram depicting a method for granting verification of biometric information at an identity verification server in accordance with one or more embodiments herein.

FIG. 6 is a block diagram depicting a computing machine and a module in accordance with one or more embodiments presented herein.

### DETAILED DESCRIPTION OF EXAMPLE EMBODIMENTS

### Overview

The methods and systems described herein enable a customer user's mobile device to generate and transmit a biometric verification token to a merchant terminal, such as a POS system. For example, a user making a purchase may wish to give the POS system permission to verify the user's identity from a photo or fingerprint during the sale transaction, while preventing general, unfettered access to verify the user's biometric identity in the future. The biometric verification token can give the POS system, or an associated server, permission to request verification of the user's biometric information during the transaction, or for a set of transactions. Such verification can increase security for the transaction.

The user may consent to being identified by their biometric information for a specific transaction. With such consent, the user can allow their biometric information to be collected at the POS system. This biometric information may include, among other examples, information for facial recognition, voice print matching, or fingerprint analysis. A digital wallet, or similar mechanism, associated with the mobile device may be used for payment or other transactions associated with the biometric verification. The biometric verification token may be passed to the POS system along with communication of the payment or other transaction information.

A secure, third party verification service may be accessed by the POS system, or the associated server, to request verification of the biometric information collected from the user. The biometric verification token may be passed to the secure, third party verification service to prove that the user has granted biometric verification privileges to the merchant. The authentication server may only verify the biometric information to the merchant (POS system or server) if a valid biometric verification token is provided. The biometric verification token may be a single-use token authorizing the POS system to verify the user's biometric information as part of a current transaction, but then never again. The biometric verification token also may be valid for a specific number of use events, valid during a specific time period, valid from a specific set of network addresses, valid from specified geographical areas, subject to any other set of parameters, or any combination thereof.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### System Architecture

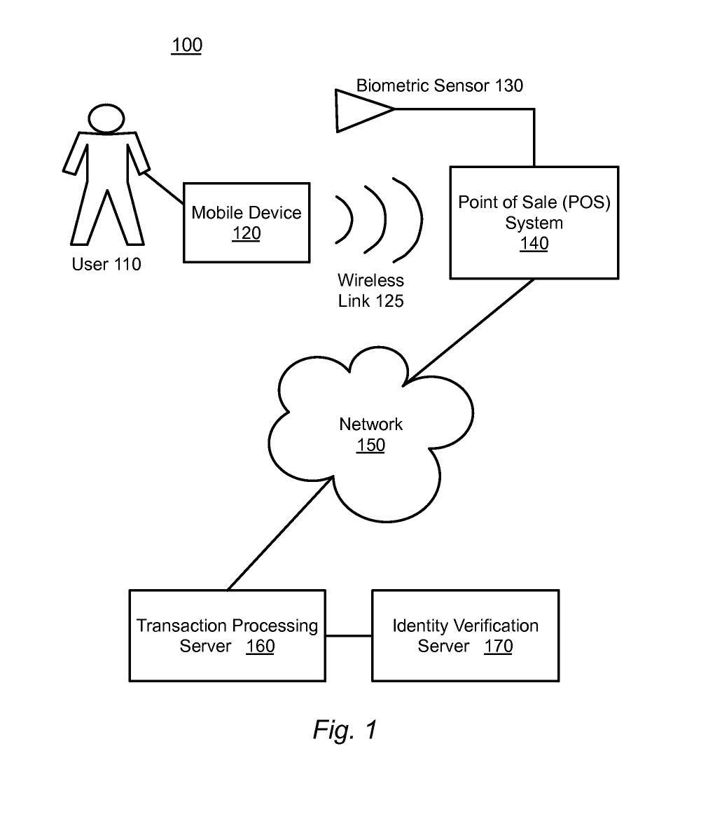

FIG. 1 is a block diagram depicting an identity verification system 100 for using biometric verification tokens to grant identity verification permission in accordance with one or more embodiments presented herein. The mobile device 120 can transmit payment information to a POS system 140. The payment information may be transmitted on behalf of a user 110 associated with the mobile device 120. The payment information may be transmitted from the mobile device 120 to the POS system 140 over a wireless link 125. A biometric sensor 130 may also provide biometric information associated with the user 110 to the POS system 140. The POS system 140 can communicate with a transaction processing server 160 to process transactions. An identity verification server 170 may be used to verify biometric information associated with the user 110. The POS system 140, the transaction processing server 160, and the identity verification server 170 may be in data communication with one another via a network 150.

The mobile device 120 may be a smartphone, a mobile phone, a netbook computer, a tablet computer, any other mobile computing device, or any computing machine. The mobile device may include a wireless communication controller for establishing a wireless link 125. The wireless link 125 may use near field communication (“NFC”) technology, a contactless interface, or any other wireless communication technology.

The POS system 140 may be used to complete financial transactions in a marketplace. For example, a vendor may configure the POS system 140 to receive payment information from a mobile device 120 as part of a transaction or sale. Similarly, the POS system 140 may be configured to receive tickets, boarding passes, or various other types of transactional information from the mobile device 120 over the wireless link 125. The POS system 140 may also receive biometric information associated with the user 110 via the biometric sensor 130.

The biometric sensor 130 may include a variety of sensor types. For example, the biometric sensor 130 may be a camera for capturing images or video of the user 110 to be used with facial recognition technology. Similarly, the biometric sensor 130 may be a microphone for recording a voice sample to be used in voice print identification. According to other examples, the biometric sensor 130 may include a fingerprint sensor, a retinal scanner, any other type of biometric information collection mechanism, or any combination thereof.

The mobile device 120 may provide transaction information to the POS system 140. The transaction information from the mobile device 120 may include payment, ticketing, boarding or other such information used for the present transaction. The transaction information from the mobile device 120 may also include user identification information such as an email address, account name/number, or any other mechanism for identifying the user 110. The transaction information from the mobile device 120 may also include the biometric validation token.

The POS system 140 may collect biometric information using the biometric sensor 130. The POS system 140 may then transmit the transaction information from the mobile device 120 along with the collected biometric information to the transaction processing server 160.

The transaction processing server 160 may receive the transaction information and biometric information from the POS system 140. The transaction processing server 160 may then relay the biometric information along with the user identification information and the biometric verification token to the identity verification server 170.

The identity verification server 170 may be configured to verify the biometric information that was originally collected using the biometric sensor 130. However, the identity verification server 170 may only grant access to the biometric verification functionality after verifying the biometric verification token. The identity verification server 170 may check that the biometric verification token is one that was correctly provided by the mobile device 120 and that the biometric verification token corresponds to the user 110 according to the user identification information also provided.

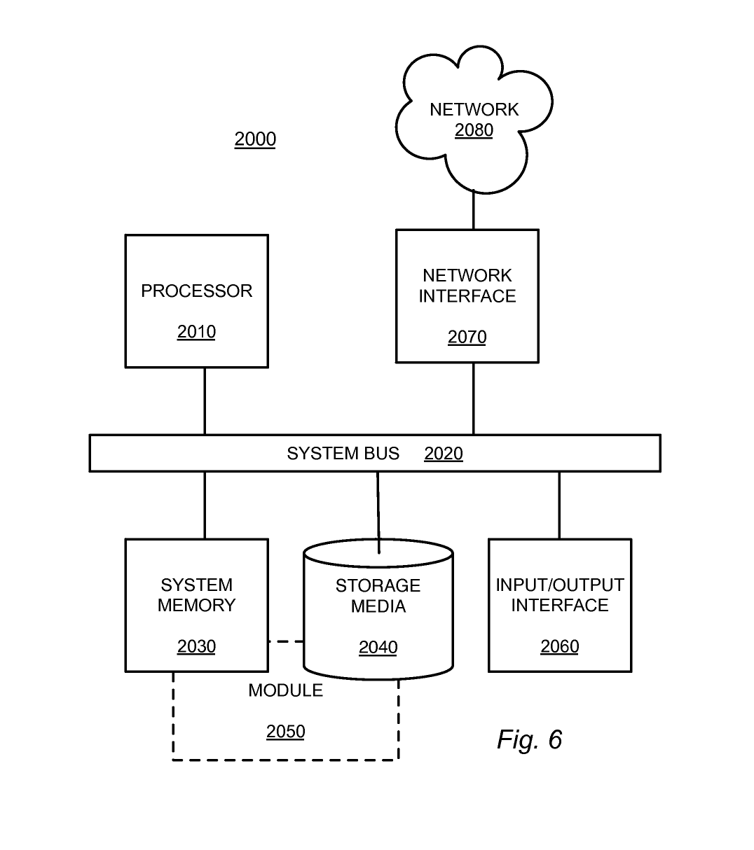

It should be appreciated that the mobile device 120, the POS system 140, the transaction processing server 160, and the identity verification server 170 may each be any type of computing machine as discussed with respect to FIG. 6 below. It should also be appreciated that network 150 may be, in part or in whole, any type of network or networking technology discussed with respect to FIG. 6 below.

The biometric verification token techniques presented herein may be useful for, among various other example scenarios, self-service checkouts in retail stores or similar automated transaction systems. For example, a customer user 110 may be making a purchase at their local supermarket using a self-service checkout station POS system 140. After scanning all of the items for purchase, the user 110 may use a digital wallet associated with their mobile device 120 as a credit card to pay for the items. The POS system 140 may use a camera, such as a webcam, to capture an image of the user 110. In addition to the credit card payment information, the mobile device 120 may provide some additional information to the POS system 140. This additional information may include an account identifier associated with the user 110 as well as an automatically generated single-use biometric verification token. The POS system 140 can transmit the information from the user 110 to the merchant's payment processing center where it is received by a transaction processing server 160. The transaction processing server 160 can send the account identifier associated with the user 110, the automatically generated single-use biometric verification token, and the image of the user 110 to the identity verification server 170. If the identity verification server 170 accepts the biometric verification token, then the identity verification server 170 can evaluate whether or not the image of the user 110 corresponds to the account identifier associated with the user 110. If the biometric image evaluation is successful, the identity verification server 170 can indicate for the transaction processing server 160 at the payment processing center to proceed with authorizing the credit card payment.

The biometric verification token may be generated at the mobile device 120 such that the biometric identification token can be verified at the identity verification server 170, where the verification can indicate that the biometric identification token likely originated from the mobile device 120 associated with the user 110. For example, the biometric verification token may include a password, a cryptographic signature, an encrypted nonce, other encrypted information, secret text, a shared secret, a time-evolving-token, a seeded time-evolving-token, any other informational token for establishing a secure identification of the user 110, or any combination thereof. The biometric verification token, or security elements associated therewith, may be shared between the mobile device 120 and the identity verification server 170 during a configuration or registration process. For example, cryptographic keys, passwords, or shared secrets serving as all, or part of, the biometric verification token may have been securely shared between the mobile device 120 and the identity verification server 170.

The user 110 may provide biometric information associated with the user 110 to the identity verification server 170 during a configuration or registration process. For example, the user may provide their photograph, fingerprints, retina scan, or other biometric identifiers to the identity verification server 170 for later use in biometric verification of the user 110.

There are three factors that may be established between the identity verification server 170 and the user 110 (or their mobile device 120) as part of a configuration or registration process. These three factors may include a user identification associated with the user 110, the known biometric information associated with the user 110 for verifying against, and the biometric verification token (or security elements associated with validating the biometric verification token). These three factors, and other related information, may be securely exchanged between the identity verification server 170 and the user 110 (or their mobile device 120) either in person or through a trusted registration/configuration process.

The biometric verification token for a particular user 110 may be specified as a single-use token for use only in the instance provided. The biometric verification token may also be valid only for a specific number of verification events, during a specific time period, from a specific set of network addresses, from specified geographical areas, subject to any other set of parameters, or any combination thereof. These, and other, token usage limitations may be specified or configured, as static parameters, for the biometric verification token beforehand by the user 110 and/or the identify verification server 170. The user 110, the mobile device 120, or the identity verification server 170 may also configure such token limitations on the fly. When such limitation are passed to the identity verification server 170 along with the biometric verifications token itself, a cryptographic wrapping, encrypting, or signing mechanism may be used to prevent malicious modification of the limitations by an attacker intending to exploit loosened restrictions on biometric verification.

It should be appreciated that while the POS system 140 is illustrated and discussed throughout this disclosure as the system interacting with the mobile device 120 and sampling the biometric information from the user 110, this is merely indicative of one or more example embodiments. According to various other embodiments, the POS system 140 (and in some embodiments, combined together with the transaction processing server 160) may be any type of transaction system such as a point of sale system, an identification system, a security system, an airport validation system, a member validation system, an employee access system, an access control system, a ticketing system, or any other system or machine wishing to collect and verify biometric information from the user 110. The transaction system may also be another user or mobile device to which the original user 110 may wish to grant permission to verify their biometric identity.

### System Process

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

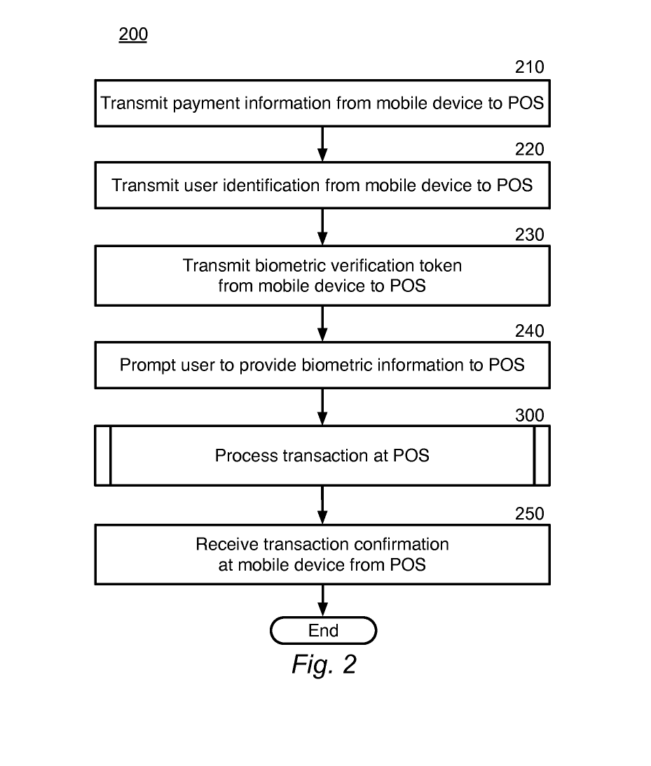

FIG. 2 is a block flow diagram depicting a method 200 for processing transactions with identity verification from a mobile device 120 in accordance with one or more embodiments presented herein.

In block 210, the mobile device 120 may transmit payment information to the POS system 140. The payment information may be associated with a credit card, a bank account, a ticketing account, a membership, or any other type of transactional information associated with the user 110. The payment information may also include user personal identification numbers (“PINs”), expiration dates, amounts limits, transaction limits, or other related information.

In block 220, the mobile device 120 may transmit user identification information to the POS system 140. The user identification information may be associated with user 110 for the purpose of validating biometric information collected from the user 110. The user identification information may include user names, account names, or other identifiers used by the system 100 to identify the user 110.

In block 230, the mobile device 120 may transmit a biometric verification token to the POS system 140. The biometric verification token may be generated at the mobile device 120 such that the biometric identification token can be verified at the identity verification server 170. Such verification can indicate that the biometric identification token likely originated from the mobile device 120 associated with the user 110. For example, the biometric verification token may include a password, a cryptographic signature, an encrypted nonce, other encrypted information, secret text, a shared secret, a time-evolving-token, a seeded time-evolving-token, any other informational token for establishing a secure identification of the user 110, or any combination thereof. The biometric verification token may be a single-use token similar to the one-time passwords (“OTP”) numbers used for two-factor authentication. The biometric verification token may also be valid for a specific number of verification events, during a specific time period, from a specific set of network addresses, from specified geographical areas, subject to any other set of parameters, or any combination thereof.

In block 240, the mobile device 120 (or alternatively the POS system 140) may prompt the user 110 to provide biometric information to the POS system 140. The user 110 may then provide the their biometric information to the POS system 140 through the biometric sensor 130. This biometric information may involve facial images, fingerprint scans, voice prints, retinal scans, or various other forms of biometric information.

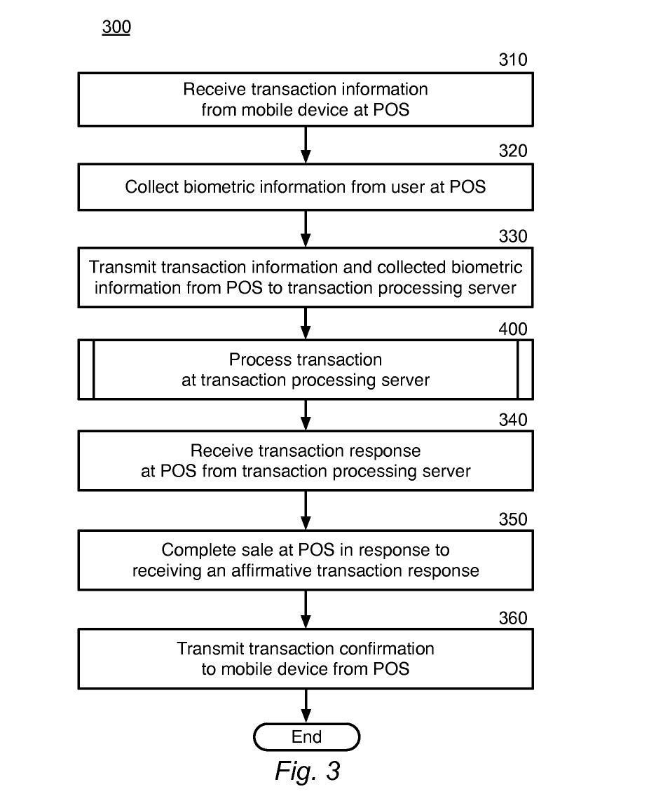

After block 240, the method 200 may continue to the method 300 as a subroutine for processing transactions at the POS system 140. The method 300 is discussed in further detail with respect to FIG. 3 below. After processing the transaction at the POS system 140 according to method 300, the method 200 may continue to block 250.

In block 250, the mobile device 120 may receive transaction confirmation (or rejection) from the POS system 140. The transaction confirmation received at the mobile device 120 may be used to indicate the completion of the transaction to the user 110. The transaction confirmation may also include an email, instant message, or other type of receipt that may be stored for future use on the mobile device 120 or printed out. Similarly, the transaction confirmation may be stored in a digital or virtual wallet associated with the mobile device 120 and the user 110.

After block 250, the method 200 ends. Of course, transaction processing from the mobile device 120 may continue through repeated application of method 200.

FIG. 3 is a block flow diagram depicting a method 300 for processing transactions with identity verification at a POS system 140 in accordance with one or more embodiments presented herein.

In block 310, transaction information may be received at the POS system 140 from the mobile device 120. The transaction information may be received from the mobile device 120 over wireless link 125. The transaction information may include the payment information transmitted by the mobile device 120 in block 210 such as account numbers, credit card information, or debit information. The transaction information may include the user identification information associated transmitted from the mobile device 120 at block 220. The transaction information may also include the biometric verification token transmitted by the mobile device 120 at block 230.

In block 320, the POS system 140 may collect biometric information from user 110 using the biometric sensor 130. The biometric information may include images or video for facial recognition, fingerprints, retinal scans, or any other type of biometric information collected from the user 110.

In block 330 the POS system 140 may transmit the transaction information received in block 310 and the biometric information collected in block 320 to the transaction processing server 160. After block 330, the method 300 may transition to method 400 as a subroutine for processing transactions at the transaction processing server 160.

The method 400 is discussed in further detail with respect to FIG. 400 below. After subroutine processing according to method 400, the current method 300 may continue to block 340.

In block 340, a transaction response may be received at the POS system 140 from the transaction processing server 160. The transaction response from the transaction processing server 160 may indicate the success or failure of the transaction transmitted to the transaction processing in server 160 in block 330. The transaction may have been successful or the transaction may have failed due to incorrect or invalid payment information or incorrect or invalid biometric verification. A failed biometric verification may have occurred due to an incorrect or invalid biometric verification token or incorrect or invalid biometric information collected at the biometric sensor 130.

In block 350, the POS system 140 may complete the sale associated with the present transaction in response to receiving an affirmative transaction response at block 340. For example, completing the sale may include updating accounting or inventory systems according to the items sold in the present transaction.

In block 360, the POS system 140 may transmit transaction confirmation information to the mobile device 120. If the sale and transaction was complete successfully, the transaction confirmation information may include an email message, other confirmation, or a receipt sent to the mobile device 120. If the transaction was not successful, the transaction confirmation information transmitted to the mobile device 120 may include an error message or information regarding the cause of failure of the transaction.

After block 360, the method 300 ends. Of course transaction processing at the POS server 140 may continue through repeated application of method 300.

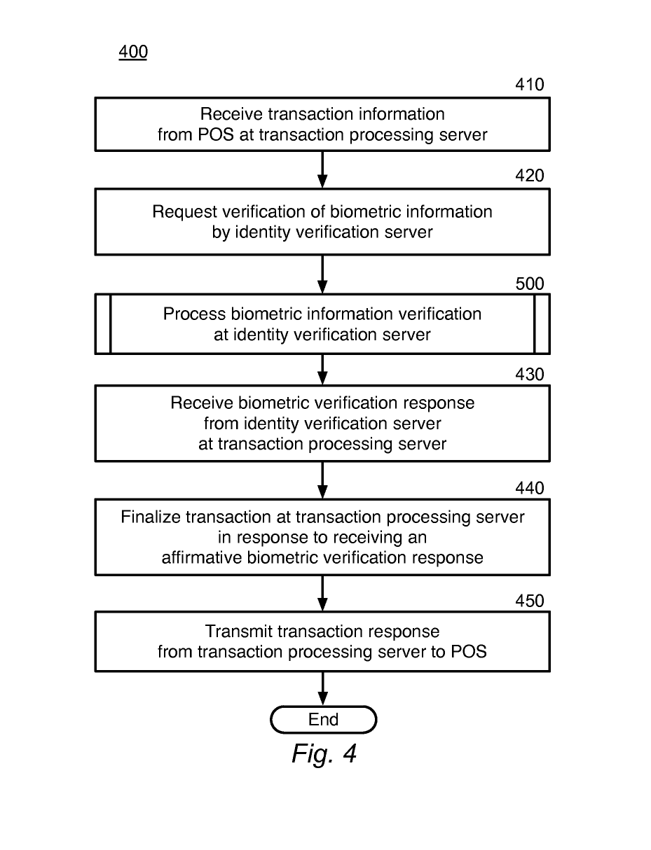

FIG. 4 is a block flow diagram depicting a method 400 for processing transactions with identity verification at a transaction processing server 160 in accordance with one or more embodiments presented herein.

In block 410, the transaction processing server 160 may receive transaction information transmitted from the POS system 140. The transaction information may have been transmitted from the POS system 140 according to block 330. The transaction information may include the payment information, such as account numbers or credit card information, as well as biometric verification information including the biometric information biometric verification token, and identification information associated with the user 110.

In block 420, the transaction processing server 160 may request verification of the biometric information by the identity verification server 170. As part of the request, the transaction processing server 160 may provide the user identification information, the biometric verification token, and the biometric information to the identity verification server 170. After block 420, the method 400 may transition to method 500 as a subroutine for processing biometric information verification at the identity verification server 170.

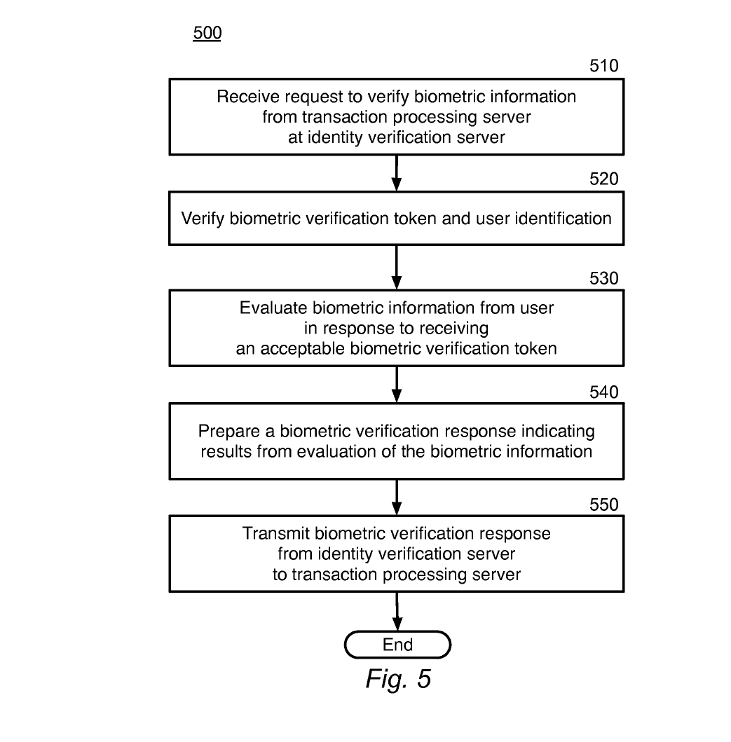

Method 500 is discussed in further detail with respect to FIG. 5 below. Upon completion of method 500 as a subroutine, the method 400 may continue at block 430.

In block 430, the transaction processing server 160 may receive a biometric verification response from the identity verification server 170. The biometric verification response may indicate whether the biometric verification token was validated for user 110 at the identity verification server 170. If the biometric verification token was acceptable, the biometric verification response may also include an indication whether or not the biometric information collected from the biometric sensor 130 was a valid match for the user 110. If the biometric verification token failed, the identity verification server 170 may skip evaluation of the biometric information.

In block 440, the transaction processing server 160 may finalize the transaction in response to receiving an affirmative biometric verification response in block 430. Such an affirmative biometric verification response indicates an affirmative match between the biometric information collected from the biometric sensor 130 and the user 110. The transaction processing server 160 may finalize the transaction according to payment information received from the POS system 140. Such transaction finalization may include transferring or accounting for payments from the payment information of the user 110 to the merchant associated with the POS system 140.

In block 450, the transaction processing server 160 may transmit a transaction response to the POS system 140. The transaction response may be received at the POS system 140 as discussed with respect to block 340. The transaction response may indicate the success or failure status of verifying the biometric information as well as the success or failure status of finalizing the transaction according to the payment information.

After block 450, the method 400 ends. Of course the processing of transactions at the transaction processing server 160 may continue according to repeated application of method 400

FIG. 5 is a block flow diagram depicting a method 500 for granting verification of biometric information at an identity verification server 170 in accordance with one or more embodiments herein.

In block 510, the identity verification server 170 can receive a request to verify biometric information from the transaction processing server 160. The request may provide the biometric information collected using the biometric sensor 130, the identification information associated with user 110, and the biometric verification token provided by the mobile device 120.

In block 520, the identity verification server 170 may verify the biometric verification token in light of the user identification information. The biometric verification token generated by the mobile device 120 may include a password, a cryptographic signature, other encrypted information, or any other secure mechanism for authenticating the token as originating from the mobile device 120. The biometric verification token can authorize the identity verification server 170 to evaluate biometric information associated with user 110. Verification of the biometric verification token may include password or passphrase checking, signature verification, decryption, or other secure processing to authenticate the biometric verification token as originating from the mobile device 120 associated with the user 110.

The biometric verification token may be specified for a single use or a certain number of uses. The biometric verification token may also be specified to operate within a specific time window. The biometric verification token may also be tied to a specific merchant, company, or set of entities in order to prevent third party or outside access to biometric verification services associated with the user 110. Other such limitations of time, place, merchant, and so forth may be included within the grant of the biometric verification token. Such limitations can allow the merchant associated with the POS system 140 to verify the biometric information of the user 110 for a single or limited number of transactions without providing unfettered access to the merchant for verifying the biometric information associated with the user 110.

In block 530, the identity verification server 170 may evaluate the biometric information from user 110 in response to receiving an acceptable biometric verification token. The evaluation of the biometric information may include verifying facial measurements for face recognition, voice print signatures, fingerprints, retinal scans, or various other biometric information that may have been collected from the user 110 at the biometric sensor 130.

In block 540, the identity verification server 170 can prepare a biometric verification response indicating the results in evaluating the biometric information in block 530. The biometric verification response may indicate a success or failure of the authorization authentication of the biometric verification token as well as the success or failure of the evaluation of the biometric information in light of the user identification information.

In block 550, the identity verification server 170 may transmit the biometric verification response prepared in block 540 to the transaction processing server 160. After block 550, the method 500 ends. Of course processing biometric information verification at an identity verification server 170 may be continued through repeated application of method 500.

### General

FIG. 6 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed herein collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of the embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A system, comprising:
a mobile computing device associated with a customer;
a point of sale computing device associated with a merchant; and
an identity verification computing device,
wherein the point of sale computing device is configured to:
receive a customer identification from the mobile computing device identifying the customer,
receive a biometric verification token from the mobile computing device, and
sample biometric information from the customer; and
wherein the identity verification computing device is configured to:
receive a request from the point of sale computing device to evaluate the biometric information from the customer,
receive the biometric verification token from the point of sale computing device,
authenticate the biometric verification token as originating from the mobile computing device,
evaluate the biometric information for substantially corresponding to the customer identification in response to affirmatively authenticating the biometric verification token, and
transmit a result of the evaluation to the point of sale computing device.

2. The system of claim 1, wherein the identify verification computing device receives the request from the point of sale computing device via a transaction processing system, the identify verification computing device receives the biometric verification token from the point of sale computing device via the transaction processing system, and the identify verification computing device transmits the result to the point of sale computing machine via the transaction processing system.

3. The system of claim 1, wherein the mobile computing device is further configured to provide payment information to the point of sale computing device.

4. The system of claim 1, wherein the biometric information comprises one or more of a facial image, a voice audio sample, a fingerprint, and a rental scan of the customer.

5. The system of claim 1, wherein the customer identification comprises one or more of a name, an account name, an account number, and an email address.

6. The system of claim 1, wherein authenticating the biometric verification token comprises one or more of verifying a password, verifying a shared secret, verifying a cryptographic signature, verifying a personal identification number, verifying a seeded-time-evolving-token, and decrypting information.

7. The system of claim 1, wherein the mobile computing device is a smartphone.

8. The system of claim 1, wherein communication between the mobile computing device and the point of sale computing device comprises near field communications technology.

9. A computer-implemented method for validating customer identity with biometric information, comprising:
receiving, at an identity verification computing device, a customer identification provided to a transaction computing device by a mobile computing device associated with a customer;
receiving, at the identity verification computing device, a biometric verification token provided to the transaction computing device by the mobile computing device;
receiving, at the identity verification computing device, a sample of biometric information provided to the transaction computing device by the customer;
authenticating, by the identity verification computing device, the biometric verification token as originating from the mobile computing device;
evaluating, at the identity verification computing device, whether the biometric information substantially corresponds to the customer identification in response to affirmatively authenticating the biometric verification token; and
transmitting, from the identity verification computing device, a result of the evaluation to the transaction computing device.

10. The computer-implemented method of claim 9, wherein the transaction computing device comprises one of a point of sale system, an identification system, a security system, an airport validation system, a member validation system, and an access control system.

11. The computer-implemented method of claim 9, wherein the mobile computing device is configured to provide payment information to the transaction computing device over a contactless interface.

12. The computer-implemented method of claim 9, wherein the biometric information comprises one or more of a facial image, a voice audio sample, a fingerprint, and a rental scan associated with the customer.

13. The computer-implemented method of claim 9, wherein the customer identification comprises one or more of a name, an account name, an account number, and an email address.

14. The computer-implemented method of claim 9, wherein authenticating the biometric verification token comprises one or more of verifying a password, verifying a shared secret, verifying a cryptographic signature, verifying a personal identification number, verifying a seeded-time-evolving-token, and decrypting information.

15. The computer-implemented method of claim 9, wherein the biometric verification token grants permission for the identity verification computing device to evaluate the biometric information associated with the user, on behalf of the transaction computing device, for a limited number of transactions.

16. The computer-implemented method of claim 9, wherein the biometric verification token grants permission for the identity verification computing device to evaluate the biometric information associated with the user, on behalf of the transaction computing device, during a specified time period.

17. A computer program product, comprising:
a non-transitory computer-readable medium having computer-readable program code embodied therein that, when executed by one or more computing devices, perform a method comprising:
receiving transaction payment information from a mobile computing device associated with a customer;
receiving a customer identification associated with the customer from the mobile computing device;
receiving a biometric verification token from the mobile computing device;
collecting a sample of biometric information from the customer;
transmitting the biometric verification token to an identity verification service to be authenticated as originating from the mobile computing device;
transmitting the biometric information to the identity verification service for evaluation as corresponding to the customer identification, wherein the identity verification service blocks performance of the evaluation in response to a failed authentication of the biometric verification token;
receiving a response from the identity verification service indicating a result of authenticating the biometric verification token and of evaluating the biometric information; and
completing a transaction associated with the transaction payment information in response to the response from the identity verification service indicating a successful evaluation of the biometric information.

18. The computer program product of claim 17, wherein the biometric verification token grants permission for the identity verification service to evaluate the biometric information associated with the user for a limited number of transactions.

19. The computer program product of claim 17, wherein the biometric information comprises one or more of a facial image, a voice audio sample, a fingerprint, and a rental scan associated with the customer.

20. The computer program product of claim 17, wherein the customer identification comprises one or more of a name, an account name, an account number, and an email address associated with the customer.

21. The computer program product of claim 17, wherein the biometric verification token comprises one or more of a password, a shared secret, a cryptographic signature, a personal identification number, a seeded-time-evolving-token, and encrypted information.
